(19) United States
(12) Patent Application Publication
(10) Pub. No.: US 2011/0175797 A1
(43) Pub. Date: Jul. 21, 2011

(54) IMAGE DISPLAY DEVICE

(75) Inventors: Isao Tomisawa, Kawasaki (JP); Masaru Ishikawa, Kawasaki (JP); Shinya Yoshida, Tokorozawa (JP); Takehiro Takahashi, Yokohama (JP)

(73) Assignee: Pioneer Corporation, Kawasaki-shi Kanagawa (JP)

(21) Appl. No.: 13/120,982

(22) PCT Filed: Sep. 26, 2008
(86) PCT No.: PCT/JP2008/067396

§ 371 Date: Mar. 25, 2011

(51) Int. Cl. G09G 5/00

(52) U.S. Cl. 345/6

(57) ABSTRACT

An image display device 1 includes a display unit 10 having an image screen 11; an image transfer panel 20 located on a path of light left from the image screen 11; and a floating image display unit 110 that displays, as a floating image P2, the light left from the image screen 11 in a space, the space being located on one side of the image transfer panel 20 opposite to the other side thereof facing the display unit 10; a position detector 120 that detects a position of a mobile terminal; an information transceiver 130 that transmits/receives information to/from the mobile terminal 2; and an image controller 140 that controls the floating image P2 and a terminal image P3 displayed on a screen of the mobile terminal 2. The image controller 140 changes each of the floating image P2 and the terminal image P3 while linking the floating image P2 and the terminal image P3 to each other based on the position of the mobile terminal 2 and transmission situation of information to be transmitted and received with respect to the mobile terminal 2.

### TECHNICAL FIELD OF THE INVENTION

The present invention relates to image display devices for stereoscopically displaying two-dimensional images.

### BACKGROUND ART

Recently, various systems for providing viewers stereoscopic images are proposed.

In these types of image display devices, there are common systems that use binocular parallax to thereby provide, as three-dimensional images, two-dimensional images on an image screen of a display or the like.

However, because a viewer watches a pseudo image as a three-dimensional image of a target object with the focus on the image screen and the convergence being off from each other, these systems using the binocular parallax may cause the viewer to be subjected to physiological effect.

Thus, as another system, an image display device, in which an image transfer panel (for example, a microlens array consisting of a plurality of lenses) is placed in front of a two-dimensional image at a predetermined space therefrom, for displaying a pseudo stereoscopic image (floating image) of the two-dimensional image onto a space in front of the image transfer panel has been known (for example, see a first patent document).

The image display device is adapted to focus the two-dimensional image by the image transfer panel while floating the two-dimensional image, thus displaying the two-dimensional image as if to display a three-dimensional image.

Such image display devices include image display devices that have two image screens for two-dimensional images. An image to be displayed on one of the two image screens is recognized as a pseudo-stereoscopic image of the two-dimensional image, and an image to be displayed on the other thereof is recognized as a direct view image (see, for example, a second patent document).

Such image display devices also include image display devices that carry out interactive communications with floating images (see, for example, a third patent document and a fourth patent document). For example, the third patent document discloses a technology that detects the position of an object, such as a finger of a viewer, and changes a floating image according to the detected position of the object. The fourth patent document discloses a technology that detects the attribute of an object, such as a tool, and changes a floating image according to the detected attribute.

First patent document: 2003-333623

Second patent document: 2005-234240

Third patent document 2005-141102

Fourth patent document International Publication NO. WO/2008/041315

### DISCLOSURE OF THE INVENTION

### Problems to be Solved by the Invention

Nowadays, exchanging information using mobile terminals, such as cellular phones, with another information terminal grows active. For example, displayed two-dimensional codes are read to incorporate required information in mobile terminals, and photographic-image data taken by mobile terminals are connected with a printer to be printed thereon.

If these exchanges between mobile terminals and information terminals were carried out using new nonconventional interfaces to provide users dynamic impact in transfer operation, information providing services using mobile terminals could be promoted.

The present invention has been made to solve the aforementioned circumstances, and has an example of a purpose of providing image display devices that implement exchanges of information with mobile terminals in a new interface using floating images; these image display devices allow users to enjoy transfer operations of information while having an interest in them.

### Means for Solving the Problems

In order to achieve such a purpose provided above, an image display device according to claim 1 of the present invention includes a display unit having an image screen for displaying a two-dimensional image; an image transfer panel located on a path of light left from the image screen; a floating image display means that displays, as a floating image, the light left from the image screen in a space, the space being located on one side of the image transfer panel opposite to the other side thereof facing the display unit; a position detecting means that detects a position of a mobile terminal in the space; an information transmitting/receiving means that wirelessly transmits/receives information to/from the mobile terminal; and an image control means that controls the floating image and a terminal image displayed on a screen of the mobile terminal so as to be linked to each other. The image control means is configured to control, based on the position of the mobile terminal detected by the position detecting means and transmission situation of information to be transmitted and received between the information transmitting/receiving means and the mobile terminal, the floating image and the terminal image such that each of the floating image and the terminal image is changed while the floating image and the terminal image are linked to each other.

### BRIEF DESCRIPTION OF THE DRAWINGS

FIG. 1 is an outline perspective view of a floating image display unit of an image display device according to an embodiment of the present invention;

FIG. 2 is an outline view of the floating image display unit of the image display device according to the embodiment of the present invention as viewed from its lateral direction;

FIG. 3 is a structural view of an image transfer panel of the image display device according to the embodiment of the present invention;

FIG. 4 is a view describing optical operations of a microlens array that is the image display device according to the embodiment of the present invention;

FIG. 5 is a view describing optical operations of a microlens array having a structure different from that of the microlens array illustrated in FIG. 4;

FIG. 6 is an operational structural view of an image display system according to the embodiment of the present invention;

FIG. 7 is a view illustrating floating images in the image display system according to the first example of the embodiment of the present invention;

FIG. 8 is a schematic view illustrating operations of the image display system according to the first example of the embodiment of the present invention;

FIG. 9 is a schematic view illustrating operations of the image display system according to the first example of the embodiment of the present invention;

FIG. 10 is a view illustrating information to be displayed on a mobile terminal according to the first example of the embodiment of the present invention;

FIG. 11 is a flowchart illustrating operations of the image display system according to the first example of the embodiment of the present invention;

FIG. 12 is a flowchart illustrating, in detail, step S70 illustrated in FIG. 11;

FIG. 13 is a flowchart illustrating, in detail, step S80 illustrated in FIG. 11;

FIG. 14 is a view illustrating a floating image in the image display system according to the second example of the embodiment of the present invention;

FIG. 15 is a schematic view illustrating operations of the image display system according to the second example of the embodiment of the present invention;

FIG. 16 is a schematic view illustrating operations of the image display system according to the second example of the embodiment of the present invention;

FIG. 17 is a flowchart illustrating operations of the image display system according to the second example of the embodiment of the present invention;

FIG. 18 is a view illustrating a mobile image in the image display system according to the third example of the embodiment of the present invention;

FIG. 19 is a schematic view illustrating operations of the image display system according to the third example of the embodiment of the present invention;

FIG. 20 is a schematic view illustrating operations of the image display system according to the third example of the embodiment of the present invention;

FIG. 21 is a schematic view illustrating operations of the image display system according to a modification of the third example of the embodiment of the present invention;

FIG. 22 is a schematic view illustrating operations of the image display system according to a modification of the third example of the embodiment of the present invention to which real objects are added; and

FIG. 23 is a view illustrating another structure of the floating image display device according to the embodiment of the present invention.

### DESCRIPTION OF CHARACTERS

1 Floating image display device

2 Mobile terminal

10, 50 Display unit

11 Image screen

20, 20A Image transfer panel

21 Lens array half

22 Transparent substrate

23 Micro convex lens

25 Microlens array

30 Image plane

100, 100A Image display system

P1 Two-dimensional image

P2, P2A Floating image

P3 Mobile image

H Viewer (user)

### BEST MODES FOR CARRYING OUT THE INVENTION

An embodiment of the present invention will be described hereinafter with reference to the drawings.

An image display system 100 according to the embodiment is comprised of: an image display device 1 as a pseudo stereoscopic-image display device for displaying, on a preset plane in a space, two-dimensional images that are visibly recognizable by a viewer H as stereoscopic images; and a mobile terminal 3 carried by the viewer H. In the embodiment, a two-dimensional image to be displayed on a preset plane in a space will be referred to as a “floating image”. Floating images mean real images so that the viewer H can look them as if they float in a space.

In the image display system 100, an approach of the mobile terminal 2 to a floating image displayed by the image display device 1 allows communication between the image display device 1 and the mobile terminal 2, and change the floating image and a two-dimensional image displayed on the mobile terminal 2, which will be referred to as a “mobile image” while they are associated with each other. For example, linking a floating image and a mobile image with each other so that the floating image is drawn into the mobile terminal 2 and/or an image displayed on the mobile terminal 2 pops up allows transfers of information between the image display device 1 and the mobile terminal 2 to be visible, thus making the viewer H intuitively grasp data transfer.

<Structure of the Floating Image Display Device 1>

Before describing the image display system 100, the basic structure of the floating image display device 1, that is, the structure of a floating image display unit 110 having a function of displaying floating images will be described.

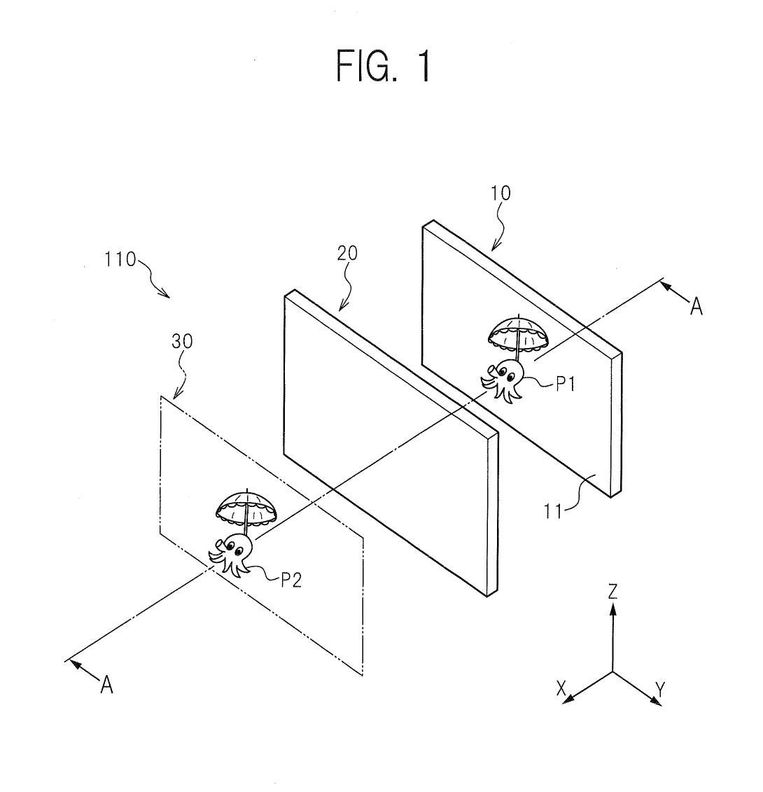

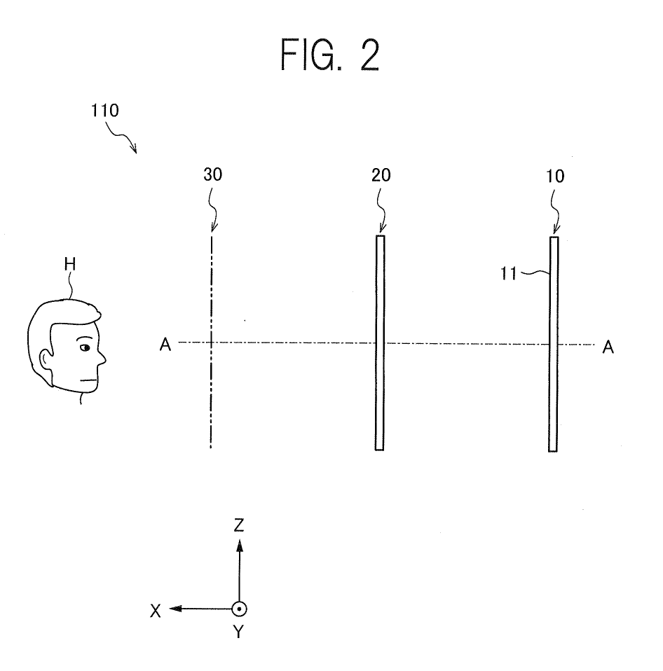

FIGS. 1 and 2 are schematically structural views of the floating image display unit 110 according to the embodiment of the present invention. FIG. 1 is an outline perspective view of the floating image display unit 110, and FIG. 2 is an outline view of the floating image display unit 110 as viewed from its lateral direction (A-A direction of FIG. 1).

The floating image display unit 110 is made up of a display unit 10, and an image transfer panel 20 located to be spaced from the display unit 10.

The display unit 10 is equipped with an image screen 11 for displaying two-dimensional images, and with a display driver (not shown) for drive and control of the display unit 10.

Specifically, as the display unit 10, a color liquid crystal display (LCD) can be used, which is provided with a flat screen 11 and a display driver consisting of an illuminating backlighting unit and a color liquid crystal drive circuit. Note that another device except for the LCD, such as an EL (Electro-Luminescence) display, a plasma display, CRT (Cathode Ray Tube), or the like, can be used.

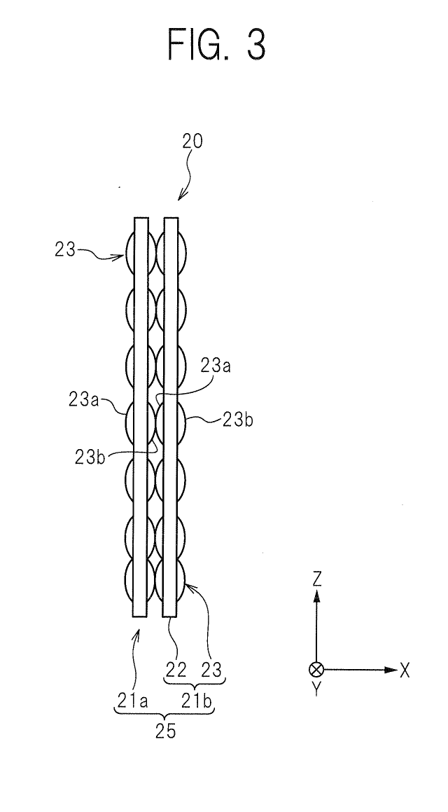

The image transfer panel 20 includes, for example, a microlens array 25 with a panel screen arranged in substantially parallel to the image screen 11 of the display unit 10. The microlens array 25, as illustrated in FIG. 3, is configured such that two lens array halves 21a, 21b are arranged in parallel to each other. Each of the lens array halves 21a, 21b is designed such that a plurality of micro convex lenses 23 are two-dimensionally arranged to be adjacent to each other on each surface of a transparent substrate 22 made from high translucent glass or resin; the micro convex lenses 23 have the same radius of curvature.

An optical axis of each of the micro convex lenses 23a formed on one surface is adjusted such that the adjusted optical axis is aligned with the optical axis of a corresponding micro convex lens 23b formed at an opposing position on the other surface. Specifically, individual pairs of the micro convex lenses 23a, 23b adjusted to have the same optical axis are two-dimensionally arranged such that their respective optical axes are parallel to each other.

The microlens array 25 is placed in parallel to the image screen 11 of the display unit 10 at a position far therefrom by a predetermined distance (a working distance of the microlens array 25). The microlens array 25 is adapted to focus light, corresponding to an image and left from the image screen 11 of the display unit 10, on an image plane 30 on the side opposite to the image screen 11 and far therefrom at the predetermined distance (working distance of the microlens array 25). This displays the image displayed on the image screen 11 on the image plane 30 as a two-dimensional plane in a space.

The formed image is a two-dimensional image, but is displayed to float in the space when the image has depth or the background image on the display is black with its contrast being enhanced. For this reason, the viewer H looks the formed image as if a stereoscopic image is projected. Note that the image plane 30 is a virtually set plane in the space and not a real object, and is one plane defined in the space according to the working distance of the microlens array 25.

Note that an effective area (specifically, an arrangement area of micro convex lenses that can effectively form entered light onto the image plane 30) and the arrangement pitches of micro convex lens arrays are floating-image display parameters of the microlens array 25. The pixel pitches, an effective pixel area, and brightness, contrast, and colors of images to be displayed on the image screen 11a of the display 11 are floating-image display parameters of the display unit 10. The floating-image display parameters of the microlens array 25 and the floating-image display parameters of the display unit 10 are optimized so that floating images to be displayed on the image plane 30 are sharply displayed.

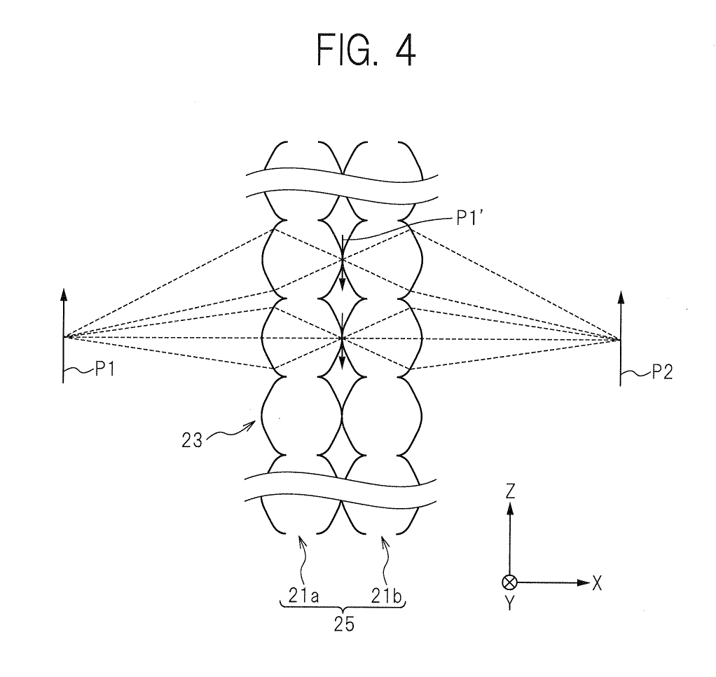

This results in that the microlens array 25, as illustrated in FIG. 4, is adjusted to be arranged such that:

light corresponding to an image P1 and left from the image screen 11 of the display unit 10 is incident from the lens array half 21a, flipped thereinside at one time, flipped again, and thereafter, outputted from the lens array half 21b.

This allows the microlens array 25 to display the two-dimensional image P1 displayed on the image screen 11 of the display unit 10 as an elected floating image P2 on the image plane 30.

More specifically, in the light forming the two-dimensional image P1 to be displayed on the image screen 11, light of an image in a region corresponding to each of the micro convex lenses 23 of the microlens array 25 is captured by each of the micro convex lenses 23, flipped in each of the micro convex lenses 23, flipped again, and outputted so that the floating image P2 is displayed as a set of elected images formed by the respective micro convex lenses 23.

Note that the microlens array 25 is not limited to the structure of a pair of two lens array halves 21a, 21b, and can be configured by a single lens array, or by a plurality of lens arrays equal to or greater than three lens arrays. Of course, when a floating image is formed by odd-numbered, such as one or three, lens array halves 21, referring to (a) and (b) of FIG. 5, light incident to the micro lens array 25 is flipped at one time therein, and flipped again. For this reason, it is possible to display an elected floating image.

As described above, various configurations of the microlens array 25 can be made. The microlens array 25 with one of these configurations allows the working distance for forming light to have a constant effective range without limiting the single working distance.

Note that, in the embodiment, the image transfer panel 20 is the microlens array 25, but not limited thereto, and can be any member for forming elected images, desirably elected equal-magnification images. Other forms of lenses, or imaging mirrors or imaging prisms except for lenses can be used.

For example, a gradient index lens array, a GRIN lens array, a rod lens array, or the like can be a microlens array, and a roof mirror array, a corner mirror array, a dove prism or the like can be a micromirror array. One Fresnel lens having a required active area, which forms a reverted image, can be used in place of arrays.

<Structure of the Image Display System 100>

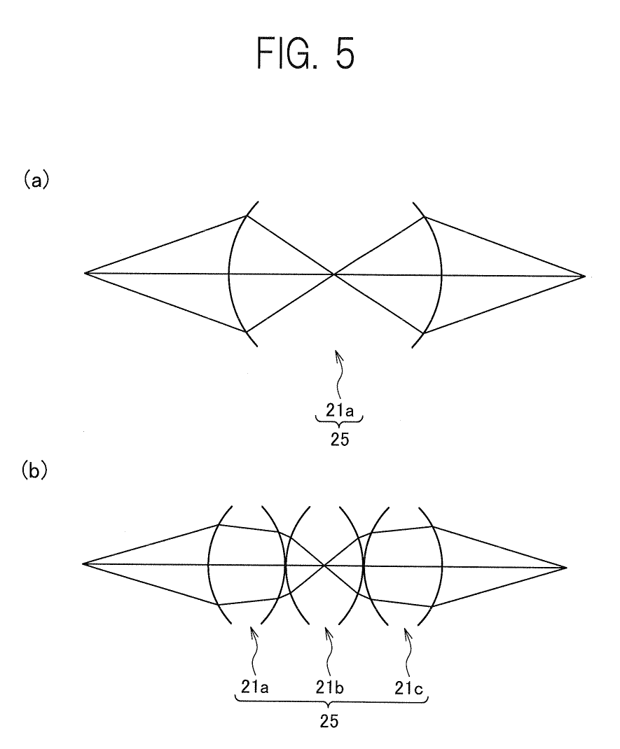

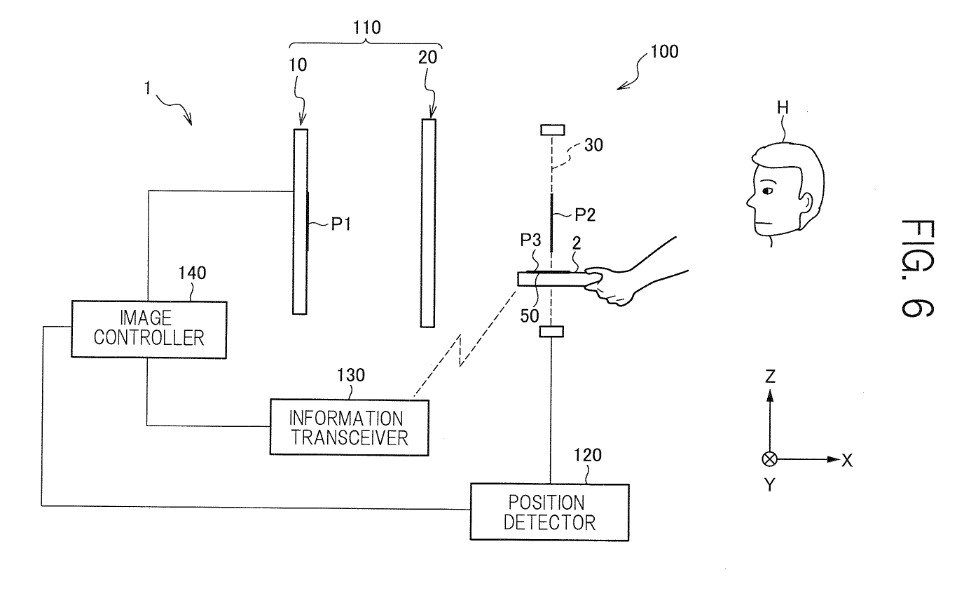

Next, the structure of the image display system 100 will be described with reference to FIG. 6. FIG. 6 is a functional structural view of the image display system 100 comprising the image display device 1 and the mobile terminal 2.

The image display system 100 substantially includes the floating image display unit 110, a position detector 120, an information transceiver 130, and an image controller 140.

The floating image display unit 110, as described above, is made up of the display unit 10 and the image transfer panel 20, and has a function of displaying the floating image P2 on the image plane 30.

The position detector 120 is a sensor for measuring the position of an object of the viewer H to be measured, such as the mobile terminal 2. The position detector 120 is adapted to output measured signals to the image controller 140. Specifically, the position detector 120 is comprised of a space sensor for measuring the position of the object to be measured in a space close to the image plane 30. Note that, as the space sensor, various types of space sensors, such as optical space sensors, can be used

The information transceiver 130 is configured to transmit information to the mobile terminal 2 and receive information transmitted from the mobile terminal 2 via wireless communications. Specifically, in response to detecting the mobile terminal 2 close to the image plane 30, the information transceiver 130 is configured to: transmit, to the mobile terminal 2, data of a mobile image P3 to be displayed on a display unit 50 of the mobile terminal 2, such as data of an icon image, data of map information, music data, or the like; and receive data stored in the mobile terminal 2, such as photo-image data. Contents of information to be transmitted and received can include images, video, text, sound, music, and so on. As the system of the wireless communications, any system of the wireless communications can be used as long as interactive communications with respect to the mobile terminal 2 far away by a range from a few centimeters to a few meters can be established. For example, a wireless LAN, Bluetooth®, Felica®, or the like can be used.

The image controller 140 is adapted to generate image data to be displayed on the display unit 10, and image data to be displayed on the display unit 50 of the mobile terminal 2, and to carry out image control such that image data to be displayed on the display unit 10 and image data to be displayed on the display unit 50 are displayed to be linked with each other.

Specifically, when the position detector 120 detects the mobile terminal 2 close to the image plane 30, the image controller 140 is configured to change the two-dimensional image P1 to be displayed on the display unit 10 and a mobile image P3 to be displayed on the display unit 50 according to signals outputted from the position detector 120 and the transmission and reception of the information transceiver 130.

That is, the image controller 140 is configured to change the floating image P2 and the mobile image P3 with their being linked with each other according to:

the position of the mobile terminal 2 as the object of the viewer H to be measured;

the transmission direction of information to be transmitted/received between the image display device 1 and the mobile terminal 2 (whether the information is transmitted from the image display device 1 to the mobile terminal 2 or from the mobile terminal 2 to the image display device 1; and

the degree of progress of the information.

For example, as described later, when the mobile terminal 2 is close to the floating image P2 of a preset object, the transmission of image data to be displayed on the display unit 50 to the mobile terminal 2 via the information transceiver 130 is controlled such that the displayed floating image P2 (an image as the source of transmission) is controlled to be gradually reduced in size, and simultaneously, the mobile image P3 of the same object (an image as the destination of transmission) is controlled to be increased in size.

The mobile terminal 2 is a mobile information terminal carriable by the viewer H. As the mobile terminal 2, any mobile terminal capable of wirelessly communicating with the information transceiver 130 can be used. For example, a mobile information terminal, such as a cellular phone, a PDA (Personal Digital Assistant), and a portable game machine, are estimated.

### FIRST EXAMPLE

Next, the first example designed that the image display system 100 is applied to a store-information providing service will be described hereinafter.

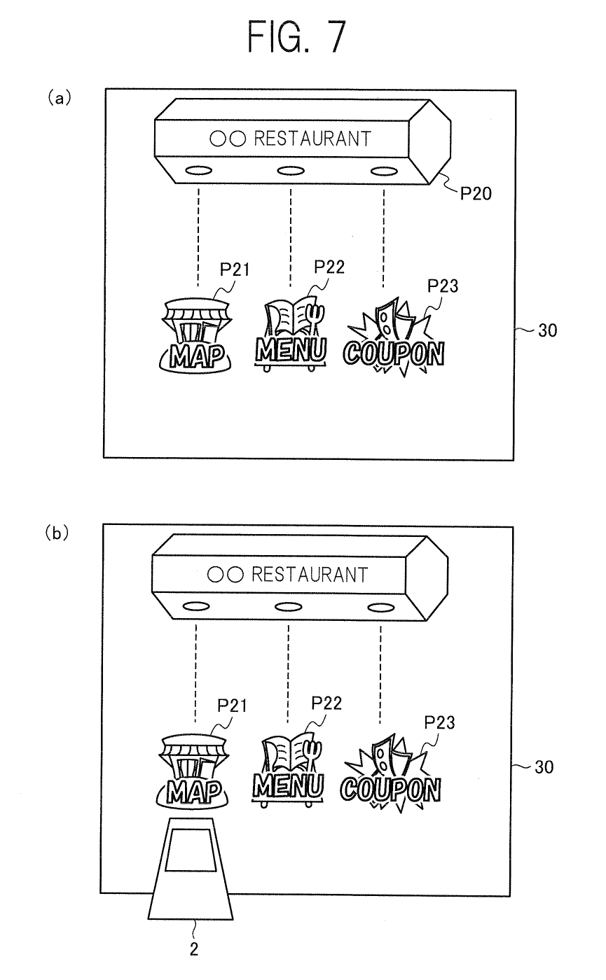

The image display device 1 according to the first example displays store information as floating images P2. For example, as illustrated in (a) of FIG. 7, as an information menu of a given restaurant, an image P20 representing the name of the restaurant, an icon image P21 that means map information of the restaurant, an icon image P22 that means menu information of the restaurant, and an icon image P23 that means coupon information of the restaurant are displayed on the image plane 30. Note that, an example illustrated in (a) of FIG. 7 illustrates that these icon images are controlled to gradually fall from respective holes formed on the image P20.

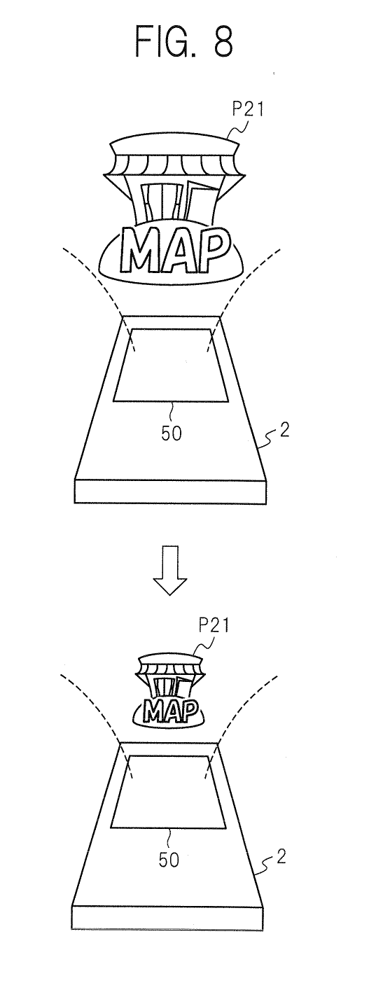

In this state, the viewer H inserts the mobile terminal 2 carried thereby into the image plane 30. For example, as illustrated in (b) of FIG. 7, when the mobile terminal 2 is close to the icon image P21 to be into below the icon image P21, as illustrated in FIG. 8, the icon image P21 is displayed to be gradually reduced in size. Specifically, the image display system 1 controls the icon image P21 such that the icon image P2 is gradually reduced in size in response to the insertion of the mobile terminal 2 into below the icon image P21. This results in that the viewer H views image representation as if the icon image P21 is absorbed into the mobile terminal 2.

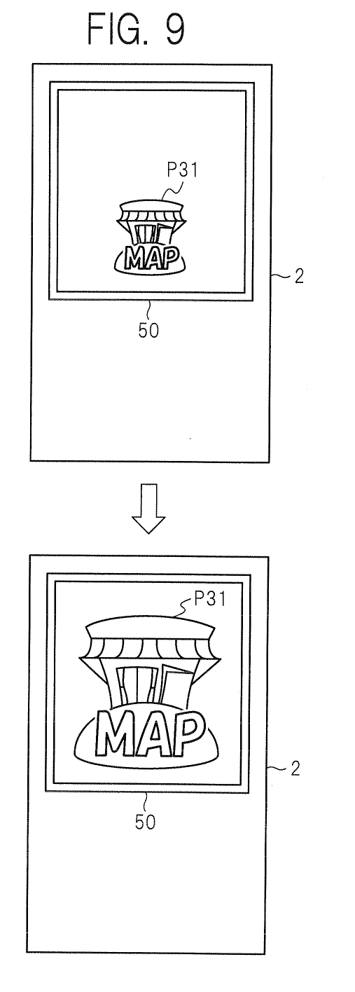

On the other hand, as illustrated in FIG. 9, an icon image P31 representing an icon identical to the icon image P21 is displayed on the display unit 50 of the mobile terminal 2 so as to be gradually increased in size. Specifically, in response to the insertion of the mobile terminal 2 into below the icon image P21, the icon image P21 is gradually reduced in size with the icon image P31 being gradually increased in size. This results in that the image representation as if an icon enters the mobile terminal 2 from air so that information is transferred to the mobile terminal 2 is carried out.

Of course, in order to carry out the image representation set forth above, in response to the insertion of the mobile terminal 2 into below the icon image P21, the image display device 1 is adapted to transmit, to the mobile terminal 2, image data of the icon image P21 and data associated with icon image P21 (for example, information that the icon image P21 represents, such as map information of the restaurant). In more detail, in this example, the image display device 1 carries out control of the icon images P21 and P31 according to the transmission situation of information to the mobile terminal 2, such as the transmission direction and the degree of progress of transmission. Specifically, when information is transmitted from the image display device 1 to the mobile terminal 2, the icon image P21 at the source of transmission is controlled to be gradually reduced in size with the icon image P31 of the destination of transmission being controlled to be gradually increased in size according to the ratio of the amount of information to be transmitted to the total transmitted amount. In other words, the icon image P21 at the source of transmission is controlled to be gradually reduced in size with the icon image P31 at the destination of transmission being controlled to be gradually increased in size as the amount of transmitted information is increased.

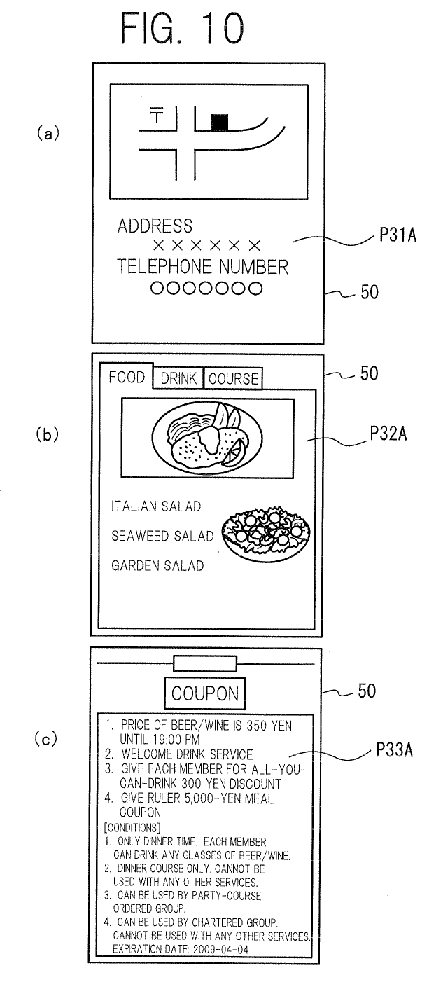

When the transmission of information from the image display device 1 to the mobile terminal 2 is completed, the icon of the icon image P31 displayed on the screen 50 of the mobile terminal 2 is developed so that developed information is displayed. For example, as illustrated in FIG. 9, when the icon image P31 is displayed on the screen 50, map information P31A of the restaurant is displayed as illustrated in (a) of FIG. 10. Note that (b) of FIG. 10 illustrates menu information P32A to be displayed after the icon image P32 is displayed on the mobile terminal 2 when the mobile terminal 2 is inserted into below the icon image P22 of the information menu illustrated in FIG. 7. (c) of FIG. 10 illustrates coupon information P33A to be displayed after the icon image P33 is displayed on the mobile terminal 2 when the mobile terminal 2 is inserted into below the icon image P23 of the information menu illustrated in FIG. 7.

As described above, in the first example, insertion of the mobile terminal 2 into the image plane 30 on which floating images are displayed causes icons floating in air as the floating images to be taken from the air into mobile terminal 2, and information of the taken icons (map information, menu information, coupon information, and the like) to be displayed on the mobile terminal 2. This makes it possible to show the viewer H that desired data is transferred to the mobile terminal 2 as image representation.

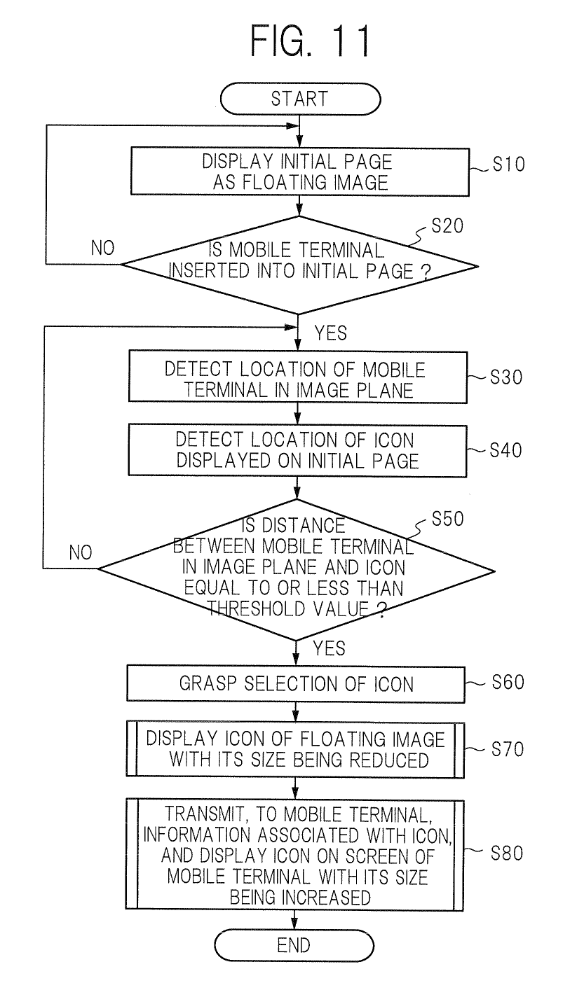

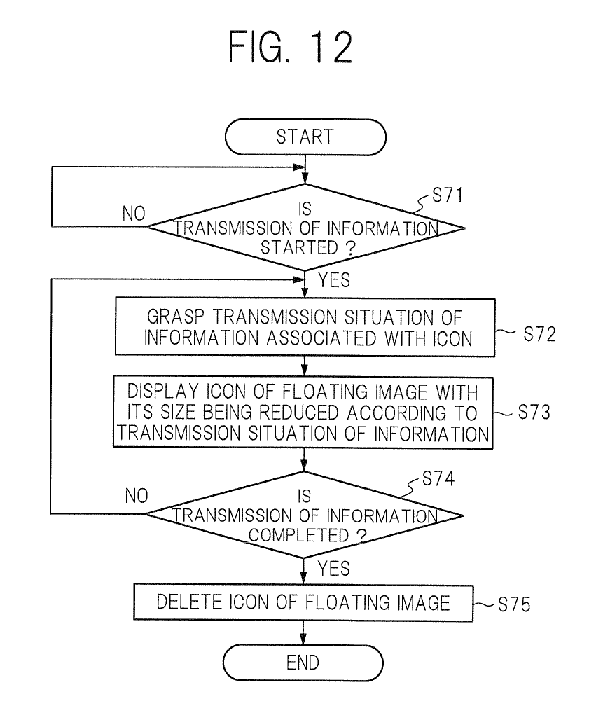

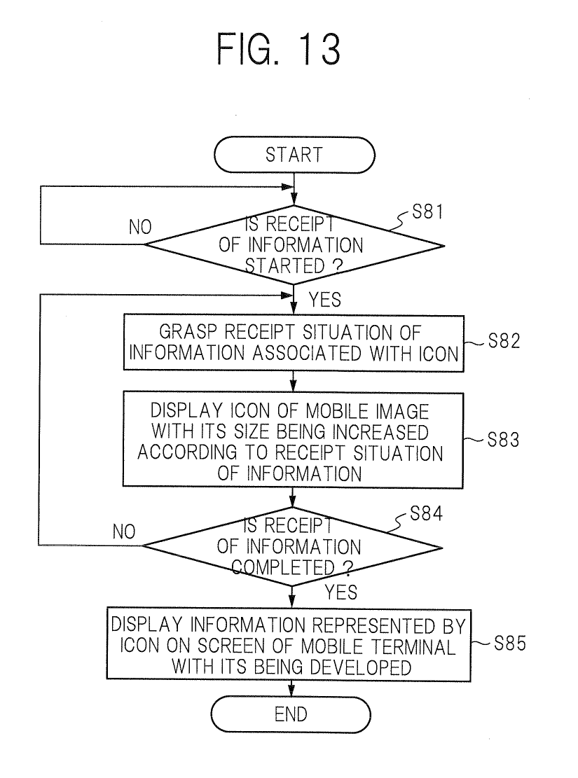

Next, operations of the image display system 100 will be described with reference to FIGS. 11 to 13. FIG. 11 is a flowchart illustrating operations of the image display device 1 according to the first example, FIG. 12 is a flowchart illustrating in detail step S70 illustrated in FIG. 11, and FIG. 13 is a flowchart illustrating operations of the mobile terminal 2 corresponding to step S80 of FIG. 11.

First, the image controller 140 of the image display device 1 displays an initial page on the image screen 30 as floating images P2 (step S10). Specifically, the information menu illustrated in FIG. 7 is displayed, and the image P20 and the icon images P21 to P23 are displayed as the floating images P2.

Next, the position detector 120 of the image display device 1 determines whether the mobile terminal 2 is inserted into the initial page (step S20). Specifically, it is determined whether the mobile terminal 2 is inserted into the image screen 30 on which the information menu illustrated in FIG. 7 is displayed.

When the mobile terminal 2 is inserted into the initial page (step S20: YES), the position detector 120 detects the location of the mobile terminal 2 in the image plane 30 (step S30), and the image controller 140 detects the location of the icons displayed on the initial page (step S40). Specifically, on the information menu illustrated in FIG. 7, the locations of the three icon images P21 to P23 that fall slowly from above are detected. Otherwise, when the mobile terminal 2 is not inserted into the initial page (step S20: NO), the initial page is continuously displayed as the floating images P2.

Next, the image controller 140 determines whether icons are within a constant range from the mobile terminal 2 (step S50). Specifically, it is determined whether the distance between the location of the mobile terminal 2 in the image plane 30 inserted in the initial page and the location of each icon is equal to or less than a threshold value.

When an icon is within the constant range from the mobile terminal 2 (step S50: YES), the image controller 140 determines that an icon within the constant range is selected (step S60), and displays the approaching icon while gradually reducing it in size (step S70). Specifically, as illustrated in (b) of FIG. 7, when the icon image P21 and the mobile phone 2 are being close to each other, the icon image P21 is displayed to fall with its size being gradually reduced as illustrated in (b) of FIG. 8.

In addition, the image controller 140 transmits, to the mobile terminal 2 via the information transceiver 130, information associated with an icon located within the constant range, thus causing the icon to be displayed on the screen 50 of the mobile terminal 2 with its size being gradually increased (step S80). Specifically, as illustrated in (b) of FIG. 7, when the icon image P21 and the mobile terminal 2 are being close to each other, as illustrated in FIG. 9, the icon image P31 identical to the icon image P21 is displayed to be gradually increased in size.

Regarding the operation in step S70, in more detail, as illustrated in FIG. 12, when starting to transmit, to the mobile terminal 2, information indicative of an icon (step S71: YES), the image controller 140 grasps transmission situation of information (step S72), and displays an icon of the floating images P2 while gradually reducing it in size according to the transmission situation of information (step S73). When the transmission of information to the mobile terminal 2 is completed (step S74: YES), the icon of the floating image P2 is deleted (step S75).

On the other hand, regarding the operation in step S80, as illustrated in FIG. 13, when starting to receive information from the image display device 1, (step S81: YES), the mobile terminal 2 grasps reception situation (step S82), and displays an icon of the mobile image P3 while gradually increasing it in size according to the reception situation (step S83). When the reception of information from the image display device 1 is completed (step S84: YES), the information of the icon is developed to be displayed (step S85).

As described above, according to the first example, when the mobile terminal 2 approaches an icon displayed in air as a floating image, the icon is displayed to be absorbed into the mobile terminal 2, and, on the screen of the mobile terminal 2, information represented by the absorbed icon is displayed to be developed. This allows the viewer H to simply and intuitively obtain desired information.

Transfer situation between the image display device 1 and the mobile terminal 2 is visually displayed using the size of icons of a floating image and a mobile image. This allows the viewer H to enjoy transferring operations themselves.

Note that, in the first example, an icon image is captured into the mobile terminal 2 by receiving the falling icon image by the mobile terminal 2 inserted in the image plane 30 without the mobile terminal 2 being moved. However, methods of capturing icons in the mobile terminal 2 are not limited to the method.

For example, moving the mobile terminal 2 inserted in the image plane 30 upwardly can capture icons into the mobile terminal 2. In this case, the speed of the icons to be captured into the mobile terminal 2 can be determined in consideration of the moving speed of the mobile terminal 2. For example, when an icon is captured into the mobile terminal 2 by receiving the falling icon by the mobile terminal 2 inserted in the image plane 30 without the mobile terminal 2 being moved, the icon can be displayed to be slowly absorbed thereinto. When an icon is captured into the mobile terminal 2 by rapidly moving the mobile terminal 2, the icon can be displayed to be immediately absorbed thereinto. Note that the mobile terminal 2 can be close to an icon from every direction. For example, moving the mobile terminal 2 from above down below allows the mobile terminal 2 to approach an icon, or moving the mobile terminal 2 from left to right allows the mobile terminal 2 to approach an icon.

In the first example, an example to capture one icon into the mobile terminal 2 has been described, but a plurality of icons can be captured into the mobile terminal 2 at once. For example, in the information menu illustrated in FIG. 7, making the mobile terminal 2 successively approach the three icon images P21 to P23 allows the three icons to be captured into the mobile terminal 2, and pieces of information represented by the three icons can be displayed with their being overlapped with each other on the display unit 50.

In the first example, an icon of a floating image is displayed to be gradually reduced in size with an icon of a mobile image being displayed to be gradually increased in size, in other words, an icon of a floating image and an icon of a mobile image are changed in size with their scaling relationship being kept. This concept can include that an icon of a floating image and an icon of a mobile image are reduced or increased in size with their shapes being deformed. This concept also can include that a part of an icon is gradually deleted so that the icon is reduced in size, and that a part of an icon gradually appears so that the icon is increased in size.

In the first example, after completion of transmission of information from the image display device 1 to the mobile terminal 2, the icon of the icon image P31 displayed on the screen 50 of the mobile terminal 2 is developed so that developed information is displayed. However, development of the icon image P31, that is, display of the map information P31A, can be carried out during the transmission of information. In this case, the mobile terminal 2 cannot display the icon image P31 on the screen 50 of the mobile terminal 2, but can display part of the map information P31A such that it gradually appears according to reception situation of information to be transmitted from the image display device 1 to the mobile terminal 2. After completion of reception of all information, the whole of the map can be displayed.

### SECOND EXAMPLE

Next, the second example designed that the image display system 100 is applied to a music delivery service (music listening service) will be described hereinafter.

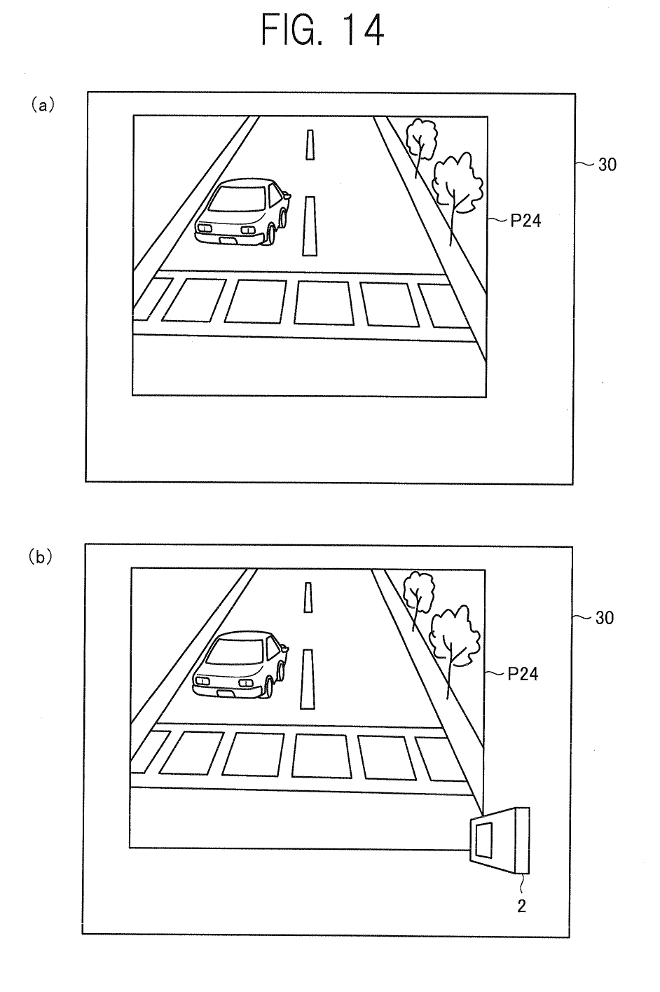

The image display device 1 according to the second example displays the jacket image of a CD as a floating image P2. For example, as illustrated in (a) of FIG. 14, the jacket image of a CD is displayed as a floating image P24 (referred to as a “jacket image”).

In this state, the viewer H inserts the mobile terminal 2 carried thereby into the image plane 30. For example, as illustrated in (b) of FIG. 14, when the mobile terminal 2 is close to the jacket image P24 to be into the lower right end of the jacket image P24, a part of the jacket image P24, which is close to the position in which the mobile terminal 2 is inserted, is deleted. Thus, moving the mobile terminal 2 inserted in the jacket image P24 along the image plane 30 sequentially deletes the jacket image P24 along the trajectory of the moved mobile terminal 2. Specifically, because the image display device 1 controls deletion of a predetermined area of the jacket image P24 close to the position of the mobile terminal 2, moving the mobile terminal 2 allows areas of the jacket image P24 through which the mobile terminal 2 has passed to be successively deleted. This results in that the viewer H views image representation as if the jacket image P24 is absorbed into the mobile terminal 2.

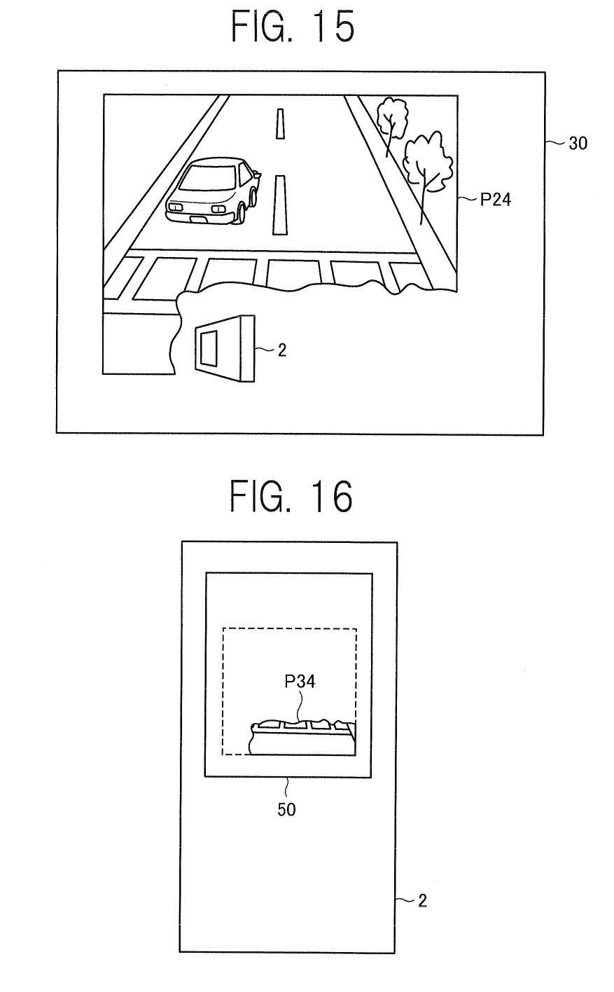

On the other hand, as illustrated in FIG. 16, an area deleted in the jacket image P24 is displayed on the display unit 50 of the mobile terminal 2 as a mobile image P24 (referred to as a “jacket image P34). Thus, according to this example, combining the jacket image P24 with the jacket image P34 provides the original jacket image. Specifically, in response to the insertion of the mobile terminal 2 into the jacket image P24, movement of the mobile terminal 2 gradually deletes the jacket image P24 with the deleted areas being gradually displayed as the jacket image P34. This results in that the image representation as if the jacket image P24 is absorbed into the mobile terminal 2 and an image of areas absorbed to be deleted are transmitted to the mobile terminal 2 is carried out.

Of course, in order to carry out the aforementioned image representation as well as the first example, in response to the insertion of the mobile terminal 2 into the jacket image P24, the image display device 1 is adapted to transmit, to the mobile terminal 2, image data of deleted regions of the jacket image P24 and listening music data. Here, the listening music data is trial listening data of music contained in a target CD having a corresponding jacket image, and configured to be played for a time duration proportional to the size of the total deleted areas. For example, when the whole of the jacket image P24 has been deleted, the listening music data can be played for one minute, and, when about quarter of the jacket image P24 has been deleted, the listening music data can be played for 15 seconds.

In more detail, in this example, the image display device 1 carries out control of the jacket images P24 and P34 according to the transmission situation of information to the mobile terminal 2, such as the transmission direction and the degree of progress of transmission. Specifically, when information is transmitted from the image display device 1 to the mobile terminal 2, the amount of information (the amount of information of image data and music data) to be transmitted is determined in proportion to the ratio of the size of the deleted areas of the jacket image P24 determined by the movement of the mobile terminal 2 to the whole size of the jacket image P24. For this reason, the jacket image P24 at the source of transmission is controlled to be gradually deleted with the deleted areas of the jacket image P24 at the destination of information gradually appearing as the jacket image P34.

Note that, when information is transmitted from the image display device 1 to the mobile terminal 2, a time duration for which music can be currently listened is displayed on the screen 50 of the mobile terminal 2 together with the jacket image P34. For example, a message “MUSIC CAN BE LISTENED FOR 15 SECONDS” or “MUSIC CAN BE LISTENED FOR ONE MINUTE” is displayed. Predetermined operations in the mobile terminal 2 allow music to be listened for a corresponding listenable time duration. After the listening, information associated with purchase of music, such as promotional information including a message “DO YOU DOWNLOAD THIS SONG AND PURCHASE IT ?” and information of stores that sell the corresponding CD, is displayed on the screen 50 of the mobile terminal 2.

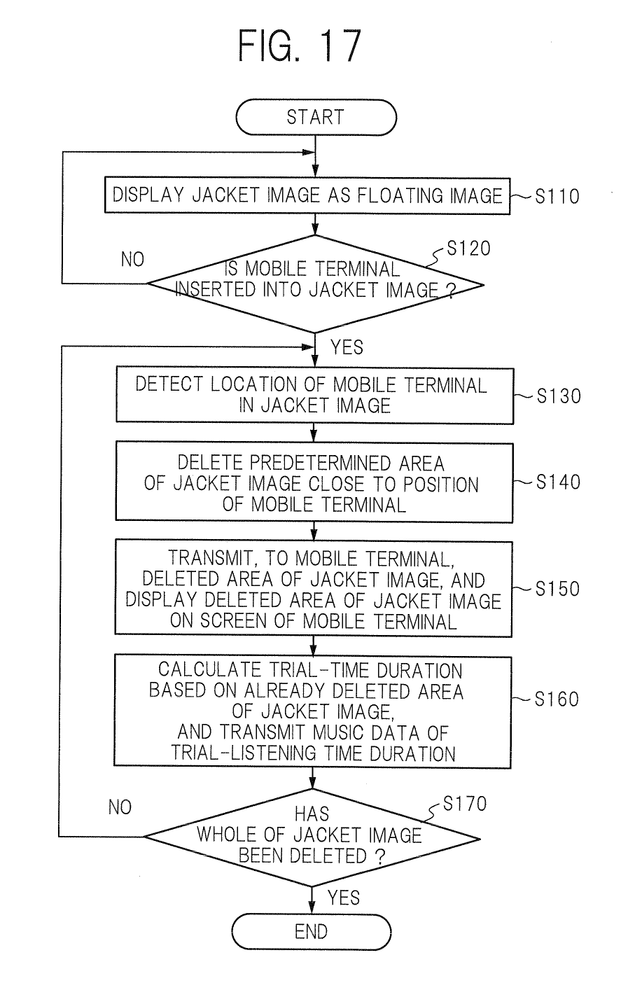

Next, operations of the image display system 100 will be described with reference to FIG. 17. FIG. 17 is a flowchart illustrating operations of the image display device 1 according to the second example.

First, the image controller 140 of the image display device 1 displays the jacket image P24 on the image screen 30 as a floating image (step S110). Specifically, the jacket image P24 illustrated in FIG. 14 is displayed.

Next, the position detector 120 of the image display device 1 determines whether the mobile terminal 2 is inserted into the jacket image P24 (step S120).

When the mobile terminal 2 is inserted into the jacket image P24 (step S120: YES), the position detector 120 detects the location of the mobile terminal 2 in the image plane 30 (step S130), and the image controller 140 deletes a predetermined area of the jacket image P24, which is close to the position in which the mobile terminal 2 is inserted (step S140).

Next, the image controller 140 transmits, to the mobile terminal 2 via the information transceiver 130, data of the jacket image corresponding to the deleted area of the jacket image P24, and causes the jacket image P34 of the deleted area to be displayed (step S150). The image controller 140 calculates a trial-listening time duration based on the already deleted areas of the jacket image P24, and transmits, to the mobile terminal 2 via the information transceiver 130, music data of the trial-listening time duration (step S160).

Next, the image controller 140 determines whether the whole of the jacket image P24 has been deleted (step S170). When the whole of the jacket image P24 has been deleted (step S170: YES), the image controller 140 terminates the routine. Otherwise, when at least part of the jacket image P24 is displayed (step S170: NO), the image controller 140 carries out the operations in steps S130 to S160 to delete areas of the jacket image P24 corresponding to a moving trajectory of the mobile terminal 2. In addition, the image controller 140 carries out control to cause the jacket image P34 corresponding to the deleted areas to be displayed on the mobile terminal 2.

Note that, when the mobile terminal 2 is not inserted into the initial page (step S120: NO), the jacket image P24 is continuously displayed as a floating image.

As described above, according to the second example, moving the mobile terminal 2 inserted in a jacket image displayed in air as a floating image allows the jacket image to be partially absorbed into the mobile terminal 2, resulting in that music associated with the jacket image can be listened by the mobile terminal 2. This allows the viewer H to simply and intuitively obtain desired information.

Transfer situation between the image display device 1 and the mobile terminal 2 is visually displayed using the appearance and disappearance of jacket images. This allows the viewer H to enjoy transferring operations themselves.

### THIRD EXAMPLE

Next, the third example designed that the image display system 100 is applied to a photo print service will be described hereinafter.

The image display device 1 according to the third example displays the explanation of a system operation manual, such as “PLEASE INSERT MOBILE PHONE INTO SCREEN AND TRANSMIT PHOTO IMAGE”, is displayed as a floating image P25A. For example, as illustrated in (a) of FIG. 14, the jacket image of a CD is displayed as a floating image P24 (referred to as a “jacket image”).

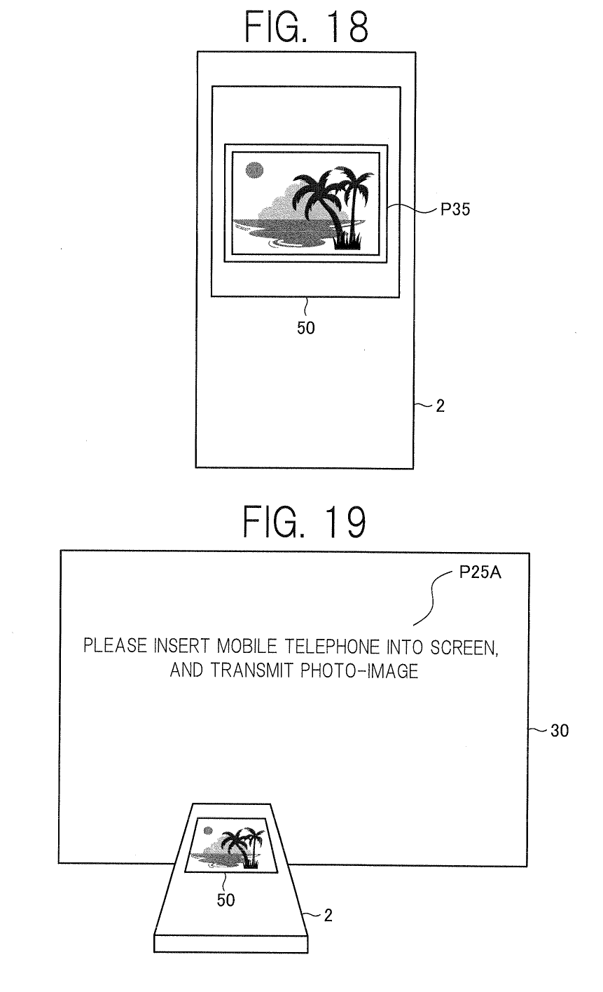

In this state, as illustrated in FIG. 18, a user (viewer H) causes a photo image P35 for printing to be displayed on the screen 50 of the mobile terminal 2 carried thereby. When the mobile terminal 2 is inserted into the image plane 30 as illustrated in FIG. 19, the photo image P35 is partially lacked gradually to be deleted with deleted parts of the photo image partially appearing gradually as a photo image P25. Thus, according to this example, combining the photo image P35 with the photo image P25 provides the original photo image. Specifically, in response to the insertion of the mobile terminal 2 into the image plane 30, the image display device 1 executes control to display the photo image P35 such that the photo image P35 is partially lacked gradually, and, simultaneously, to display the photo image P25 such that the photo image P25 partially appears gradually. This results in that the viewer H views the image representation as if the photo image P35 pops up to become a floating image, and the photo image is transferred from the mobile terminal 2 to the image display device 1

Of course, in the insertion of the mobile terminal 2 into the image plane 30, the user carries out operations of the mobile terminal 2 to output photo image data. This results in that, in response to the insertion of the mobile terminal 2 into the image plane 30, the image display device 1 is adapted to receive, from the mobile terminal 2, image data of the photo image P35. In more detail, the image display device 1 carries out control of the photo images P35 and P25 according to the reception situation of information from the mobile terminal 2, such as the transmission direction and the degree of progress of transmission. Specifically, when information is transmitted from the mobile terminal 2 to the image display device 1, the image display device 1 controls the photo image P25 at the destination of information such that the photo image P25 partially appears gradually according to the ratio of the already received amount of information to a total mount of information to be received while controlling, in the mobile terminal 2, the photo image at the source of transmission such that the photo image P35 is partially deleted gradually according to the ratio of the already transmitted amount of information to a total mount of information to be transmitted.

Finally, when the transmission of information from the mobile terminal 2 to the image display device 1 is completed, one complete photo image P25 is displayed on the image plane 30, and a photo image based on the transmitted photo image data is printed out.

As described above, according to the third example, insertion of the mobile terminal 2 into the image plane 30 for floating images with a photo image being displayed on the mobile terminal 2 to execute data output process of image data allows the photo image to be displayed as if the photo image flies out of the mobile terminal so that the photo image is printed out by the image display device 1. This allows the viewer H to simply and intuitively output transfer of desired photo images.

Transfer situation between the image display device 1 and the mobile terminal 2 is visually displayed using photo images of floating images and mobile images. This allows the viewer H to enjoy transferring operations themselves.

These descriptions set forth above show that the image display system 100 is not limited to be applied to services for transmitting information from the image display device 1 (information terminal) to the mobile terminal 2 like the first and second examples, and can be applied to services for transmitting information from the mobile terminal 2 to the image display device 1 (information terminal). As described above, image display is carried out according to the direction of transmitted or received information (the direction of information transmitted from the image display device 1 to the mobile terminal 2 or the direction of information transmitted from the mobile terminal 2 to the image display device 1), and the degree of progress of transmission and reception can be understood. Thus, the viewer H can simply, intuitively, and positively carry out communications of information with enjoyment.

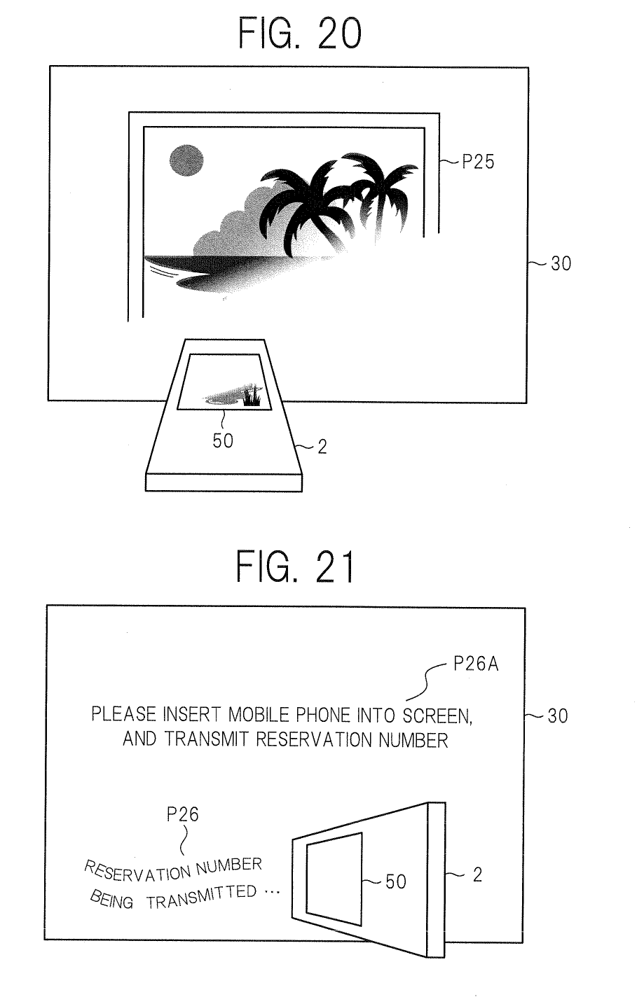

Moreover, in this example, information to be transmitted from the mobile terminal 2 to the image display device 1 is photo image data, but information to be transmitted can be variously considered for the types of services. For example, as illustrated in FIG. 21, when the image display system 100 is applied to a ticketing service, a ticket reservation number is transmitted from the mobile terminal 2 to the image display device 1.

The ticketing service illustrated in FIG. 21 assumes that a user (viewer H) has reserved a desired ticket using the mobile terminal 2. The ticketing service is designed to issue the ticket from the image display device 1 (information terminal). Specifically, first, the image display device 1 displays the explanation of a system operation manual, such as “PLEASE INSERT MOBILE PHONE INTO SCREEN AND TRANSMIT RESERVATION NUMBER” as a floating image.

In this state, as illustrated in FIG. 21, when a user (viewer H) inserts the mobile terminal 2 into the image plane 30, a message image P26 indicative of a message “RESERVATION NUMBER BEING TRANSMITTED” is displayed to pop up from the screen 50 as a floating image. Specifically, in response to the insertion of the mobile terminal 2 into the image plane 30, the image display device 1 executes control to display the message image P26 such that the message of the message image P26 appears gradually from the screen 50 from the begging thereof. This results in that the viewer H views the image representation as if the reservation number information stored in the mobile terminal 2 pops up to become a floating image, and the information is transferred from the mobile terminal 2 to the image display device 1

Of course, in the insertion of the mobile terminal 2 into the image plane 30, the user carries out operations of the mobile terminal 2 to output data of the reservation number information. This results in that, in response to the insertion of the mobile terminal 2 into the image plane 30, the image display device 1 is adapted to receive, from the mobile terminal 2, the reservation number information. In more detail, the image display device 1 carries out control of the message image P26 according to the reception situation of information from the mobile terminal 2, such as the transmission direction and the degree of progress of transmission. Specifically, when information is transmitted from the mobile terminal 2 to the image display device 1, the image display device 1 controls the message image P26 such that the message image P26 is repeatedly displayed during the reception of the information, and the message image P26 partially appears gradually according to the ratio of the already received amount of information to a total mount of information to be received.

Finally, when the transmission of information from the mobile terminal 2 to the image display device 1 is completed, a desired ticket is printed to be issued from the image display device 1 based on the transmitted reservation number.

Note that, in each of the examples, a floating image P2 and a mobile image P3 are linked to each other, resulting in visualization of communications between the image display device 1 and the mobile terminal 2. In addition to this configuration, a real object can be located close to the image plane 30 so as to achieve more interested image reservation during data transfer.

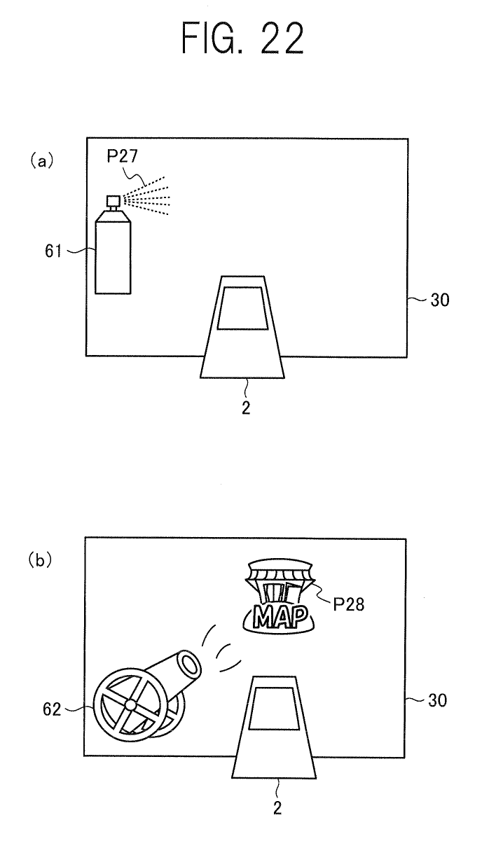

For example, as illustrated in (a) of FIG. 22, insertion of the mobile terminal 2 into the image plane 30 with a spray can 61 as a real object located close to the image plane 30 allows fog P27 from the spray can 61 to be displayed as a floating image. In this modification, making the mobile terminal 2 approach the sprayed fog P27 allows the fog P27 to be captured in the mobile terminal 2. This allows desired information to be transmitted from the image display device 1 to the mobile terminal 2.

As illustrated in (b) of FIG. 22, insertion of the mobile terminal 2 into the image plane 30 with an artillery gun 62 located close to the image plane 30 allows a bullet (icon) P28 from the artillery gun 62 to be displayed as a floating image. In this modification, making the mobile terminal 2 approach the bullet (icon) P28 launched from the artillery gun 62 allows the bullet P28 to be received. This allows desired information to be transmitted from the image display device 1 to the mobile terminal 2.

In each of the examples, information to be transmitted between the image display device 1 and the mobile terminal 2 is data itself to be displayed as a floating image P2 or a mobile image P3, but the information is not limited thereto.

For example, link information (information indicative of a linked destination in which information is stored) or index information indicative of storage destination of information stored in the mobile terminal 2 can be used.

Note that, in each of the examples, as the structure of the floating image display unit, a system that displays real images on the image plane 30 (a system that forms floating images on one plane, which will be referred to as a “3D floating vision® system”) is adopted, but the structure of the floating image display unit is not limited to the system. Any of systems that display real images in air can be employed. For example, an IP (Integral Photography) system can be adopted, which displays real images as floating images.

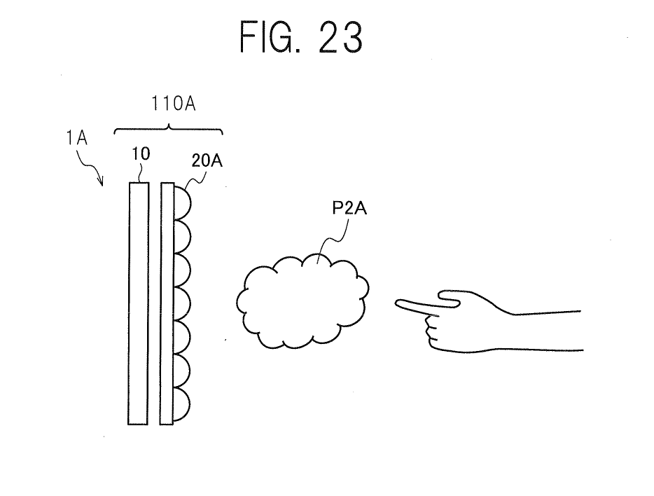

FIG. 23 is a schematic structural view of a floating image display unit 110A of an image display device 1A, which adopts the IP system.

In the IP system, as illustrated in FIG. 23, an image transfer panel 20A is placed closer to the display unit 10 in comparison to the 3D floating vision® system. Specifically, the image transfer panel 20A is, for example, a pinhole array, a microlens array, a lenticular lens, or the like. The image transfer panel 20A is used not to focus images on one plane but to change or control the direction of light left from the display unit 10. For this reason, floating images P2 are formed as floating images P2A each with a depth.

Specifically, floating images according to this embodiment include two-dimensional images P2 to be displayed on a preset plane in a space, and three-dimensional images P2A to be displayed to have a physical depth in the space.

Note that, in the IP system, because floating images P2A each with a depth are displayed, image control for two-dimensional images displayed on the display unit 10 is more complicated in comparison to the 3D floating vision® system. For this reason, in view of easily producing stereoscopic images, the 3D floating vision® system is more suitable.

The image representations described in the embodiment and the aforementioned examples are achieved only using the floating vision® system or the IP system using floating images that are real images. This is because, if the mobile terminal 2 approached a 2D display that displays two-dimensional images, the mobile terminal 2 would be in physical contact with the image screen of the 2D display, so that insertion of the mobile terminal 2 into and across a floating image would not be carried out. For this reason, a viewer H could not experience, with a realistic feeling, an image being displayed as if it is absorbed into the mobile telephone 2 or an image being displayed as if it pops up from the mobile telephone 2, which have been described in the embodiment and each of the examples.

As described above, the image display device 1 according to the embodiment comprises: the display unit 10 having an image screen 11 for displaying a two-dimensional image; an image transfer panel 20 located on a path of light left from the image screen 11; a floating image display unit 110 that displays, as a floating image P2, the light left from the image screen 11 in a space, the space being located on one side of the image transfer panel 20 opposite to the other side thereof facing the display unit 10; a position detecting unit 120 that detects a position of a mobile terminal in the space; an information transmitting/receiving unit 130 that wirelessly transmits/receives information to/from the mobile terminal; and an image controller 140 that controls the floating image P2 and a terminal image P3 displayed on a screen of the mobile terminal 2 so as to be linked to each other.

The image controller 140 is configured to control, based on the position of the mobile terminal 2 detected by the position detecting unit 120 and transmission situation of information to be transmitted and received between the information transmitting/receiving unit 130 and the mobile terminal 2, the floating image P2 and the terminal image P3 such that each of the floating image P2 and the terminal image P3 is changed while the floating image P2 and the terminal image P3 are linked to each other.

This achieves communications of information to the mobile terminal 2 through a new interface using floating images, and makes it possible for users to enjoy the transfer operations with interest.

The embodiment and examples of the present invention have been described, but the present invention is not limited to these embodiments. Various modifications and deformations can be applied to these embodiments of the present invention within the scope of the present invention. The modified or deformed embodiments are included in technical scopes of the present invention.

1.-16. (canceled)

17. An image display device comprising:
a display unit having an image screen for displaying a two-dimensional image;
an image transfer panel located on a path of light left from the image screen;
a floating image display means that displays, as a floating image, the light left from the image screen in a space, the space being located on one side of the image transfer panel opposite to the other side thereof facing the display unit;
a position detecting means that detects a position of a mobile terminal in the space;
an information communication means that wirelessly communicates with the mobile terminal to thereby carry out at least one of transmission and reception of information; and
an image control means that controls the floating image and a terminal image displayed on a screen of the mobile terminal so as to be linked to each other,
wherein the image communication means controls a wireless communication with the mobile terminal when the position detecting means detects the mobile terminal in the space, and the image control means is configured to control, based on the position of the mobile terminal detected by the position detecting means and transmission situation of the information to be communicated between the information communication means and the mobile terminal, the floating image and the terminal image such that each of the floating image and the terminal image is changed while the floating image and the terminal image are linked to each other.

18. The image display device according to claim 17, wherein the transmission situation is at least any one of a transmission direction of the information and a progress of transmission of the information.

19. The image display device according to claim 17, wherein the information communication means starts wireless communication with the mobile terminal based on a displayed position of the floating image displayed by the image control means and the position of the mobile terminal in the space detected by the position detecting means.

20. The image display device according to claim 17, wherein the image control means controls one of the floating image and the terminal image changed to be linked to each other such that the one of the floating image and the terminal image is gradually increased in size, and controls the other of the floating image and the terminal image such that the other thereof is gradually reduced in size.

21. The image display device according to claim 20, wherein the floating image and the terminal image changed to be linked to each other are images associated with a common object.

22. The image display device according to claim 17, wherein the floating image and the terminal image changed to be linked to each other are images associated with a common object, and the image control means executes control that partially deletes one of the floating image and the terminal image gradually, and executes control that gradually displays a partially deleted image of the one of the floating image and the terminal image as the other of the floating image and the terminal image.

23. The image display device according to claim 22, wherein, when partially deleting the floating image gradually, the image control means deletes, while following movement of the mobile terminal, an area of the floating image, the area being close to the position of the mobile terminal detected by the position detecting means.

24. The image display device according to claim 17, wherein the image control means develops the communicated information after the information communication means completes the wireless communication of the information.

25. The image display device according to claim 17, wherein the image control means carries out a preset operation based on the communicated information after the information communication means completes the wireless communication of the information.

26. The image display device according to claim 23, wherein the information communication means changes an amount of the information to be communicated based on an amount of the floating image to be deleted.

27. The image display device according to claim 19, wherein, when the image control means displays the floating image in plurality, if a communication condition for starting, by the information communication means, the wireless communication of the information is met, the image control means changes an amount of the information to be communicated according to a number of the communication condition met.

28. The image display device according to claim 17, wherein a real object for representation is located in the space, and the image control means displays the floating image while moving the floating image from the location of the real object.

29. The image display device according to claim 17, wherein the floating image is a real image based on the two-dimensional image displayed on the image screen.

30. The image display device according to claim 29, wherein the floating image is a real image formed on an image plane in the space by the image transfer panel.

31. An image display system comprising:
a mobile terminal with a screen; and
an image display device, the image display device comprising:
a display unit having an image screen for displaying a two-dimensional image;
an image transfer panel located on a path of light left from the image screen;
a floating image display means that displays, as a floating image, the light left from the image screen in a space, the space being located on one side of the image transfer panel opposite to the other side thereof facing the display unit;
a position detecting means that detects a position of the mobile terminal in the space;
an information communication means that wirelessly communicates with the mobile terminal to thereby carry out at least one of transmission and reception of information; and
an image control means that controls the floating image and a terminal image displayed on the screen of the mobile terminal so as to be linked to each other,
wherein the image communication means controls a wireless communication with the mobile terminal when the position detecting means detects the mobile terminal in the space, and the image control means is configured to control, based on the position of the mobile terminal detected by the position detecting means and transmission situation of the information to be communicated between the information communication means and the mobile terminal, the floating image and the terminal image such that each of the floating image and the terminal image is changed while the floating image and the terminal image are linked to each other.
